(19) United States
(12) Patent Application Publication
(10) Pub. No.: US 2026/0320541 A1
(43) Pub. Date: Oct. 15, 2026

(54) Automated Inventory System And Method Of Use Thereof

(71) Applicant: Rebound International, LLC, Houston, TX (US)

(72) Inventors: Jason Derek Cox, Houston, TX (US); Emily Brown, Houston, TX (US)

(73) Assignee: Rebound International, LLC, Houston, TX (US)

(21) Appl. No.: 19/174,496

(22) Filed: Apr. 9, 2025

(51) Int. Cl. G06Q 10/087; G06K 7/10; G06K 19/07

(52) U.S. Cl. CPC G06Q 10/087; G06K 7/10415; G06K 19/0723

(57) ABSTRACT

An inventory management system includes a containment environment for storing one or more items, each item being tagged with a radio frequency identification (RFID) tag. One or more RFID readers are disposed within the containment environment to periodically scan RFID tags within the containment environment and provide a list of RFID tags. A central server application in communication with the RFID readers, is configured to maintain an inventory list for the containment environment based on the periodic scans of RFID tags. The central; server application removes an item from said inventory list only when the RFID tag associated with the item is not detected by the one or more RFID readers for a predetermined number of successive periodic scans of the RFID tags within the containment environment.

### BACKGROUND

This disclosure relates to an automated inventory module (AIM) implementing an inventory tracking methodology. This disclosure also relates to an improved shelving unit for a shelving container. This disclosure further relates to an automated inventory system and method.

Non-productive time (NPT) affects many industries, and the current maintenance, repair and operation (MRO) supply chain is a part of that problem. To protect against downtime, work sites such as drilling rigs often keep consumable parts in one or more local storage areas (sometimes referred to herein as “containment environments”) such as consignment boxes. or more regional warehouses. However, consignment boxes may not adequately protect against unplanned downtime. Moreover, problems such as supply levels in consignment box may bel unknown by the drilling company, and theft can be rampant. Additionally, there can be discrepancies in inventory that can lead to conflicts between vendors and consumers. Lastly, “soft” costs are expended in accounting processes related to the consignment boxes. This only shows that consignment boxes do not solve the problem of non-productive time.

Regional warehouses by themselves do not solve the problem as well since regional warehouses may be hours away from the site, and this may can add to the non-productive time problems experienced the industry. Moreover, significant manpower may be required to keep track of inventory of regional warehouses. Another problem that may be encountered are human errors such as incorrect inventory counts. Furthermore, supply chains may not be interconnected and may use separate platforms when monitoring and managing their inventories. As such, it would be useful to have an improved system and method for automating inventory processes within local storage areas.

Standard shipping containers can be used as local containment environments. Shipping containers can be built with corrugated steel walls, which are designed to provide strength to the structure without significantly increasing the weight of the container. Such design makes the shipping container a viable structure for transporting, storing, and securing different products that are used for different purposes. One of the practical uses for shipping container can be providing a mobile MRO (maintenance, repair, and operating supplies) solution for drilling rig sites or other industrial sites or sites with industrial components or commercial inventory. In such system, the shipping container can be used for storing and securing purchasable products. As such, shipping container can be customized to work with a smart control system that can work with radio-frequency identification tags (“RFID tags”) RFID technology may be used to manage and maintain the operating supplies within a specific site. However, the corrugated wall structure of shipping containers can cause electromagnetic signals from RFID to disperse. Such interference can significantly affect the ability of RFID readers to read RFID tags placed on the inventory items. As such it would be useful to have an improved wall panel for an automated inventory system.

Further, storing different products within the shipping container such that products can be displayed and organized for easier access and tracking can be important in order to provide an effective mobile MRO solution for different industrial and commercial sites. However, available shelving solutions make reading RFID tags by RFID readers in a container difficult. As such, it would be useful to have an improved shelving unit for a shipping container.

Still further, there are issues relating to RFID tags not being read during one or more scans, or being only intermittently being read during RFID scans. This can happen, for example, when RFID tags are damaged or mis-applied to certain products. Thus, it would be useful to have a methodology for accurately compensating for potential spurious RFID reading of inventory items.

### SUMMARY

This disclosure relates in part to an improved wall panel for an automated inventory module. The improved wall panel can comprise a wall panel. The wall panel can be capable of being mounted at a corrugated interior surface of an automated inventory module (AIM). The wall panel can comprise a substantially flat first exterior layer comprising a first side and a second side. The first exterior layer first side can face the interior of the AIM when the wall panel is mounted at the interior surface, and the first exterior layer second side can face the interior surface when the wall panel is mounted at the interior surface. The first exterior layer can comprise a ferromagnetic material.

Additionally, systems for improving RFID reading with AIM are disclosed herein. The systems may comprise a door assembly, a wall panel, and a plurality of L-shaped frames. The wall panel may comprise a door assembly, a substantially flat first exterior layer, a middle layer, and a second exterior. The first exterior layer ma comprise a first side and a second side. The first exterior layer first side may face an interior of a shipping container when the door assembly is mounted to an AIM and in a closed position. The middle layer may be adjacent to the first exterior layer second side. The middle layer may comprise an insulation material. The second exterior may be adjacent to the middle layer such that the middle layer is between the first exterior layer and the second exterior layer. The second exterior layer may be mountable at an interior wall of the door assembly of the AIM. The plurality L-shaped frames may be placed around the sides of the wall panel. The L-shaped frames may be mounting the wall panel to the door assembly.

A system for improving electromagnetic signals within an AIM is disclosed herein. The system may comprise a first set of wall panels. Each wall panel of the first set of wall panels may be mountable at one of a plurality of interior surfaces of an AIM. Each wall panel of the first set of wall panels may comprise a substantially flat first exterior layer, a middle layer and a second exterior layer. The first exterior layer may comprise a first side and a second side. The first side may face an interior of the AIM when mounted to the one of a plurality of interior surfaces. The middle layer may be adjacent to the first exterior layer. The middle layer may comprise an insulation material. The second exterior layer may be adjacent to the middle layer such that the middle layer is placed in between the first exterior layer and the second exterior layer. The second exterior layer may be adjacent to the one of the plurality of interior surfaces of the AIM

In some examples, an improved shelving unit for a shipping container is disclosed herein. The improved shelving unit may comprise one or more shelf assemblies and an RFID reader. Each of the one or more shelf assemblies may comprise a bottom platform and a top platform. The RFID reader may be mounted between the bottom platform and the top platform. The top platform may be capable of supporting items.

In examples, an improved automated inventory system is disclosed. The improved automated system (AIS) may comprise an enclosure for storing one or more items, one or more RFID readers, and a control system. Each of the items may be tagged with an RFID (radio frequency identification) tag. The enclosure may comprise a plurality of a plurality of interior surfaces defining an interior space within said enclosure. The enclosure may also comprise one or more access points within the interior surfaces that allow access to the items within the enclosure. Each of the RFID readers may be capable of reading the RFID tag. The control system may be in communication with the one or more RFID readers. The control system may detect when an item is placed within the enclosure, and may add the item to an inventory list associated with the enclosure when the RFID tag associated with the item is detected within the enclosure by any of the one or more RFID readers. The control system may also remove the item from the inventory list when the RFID tag associated with the item is no longer detected by any of the one or more RFID readers.

Additionally, in examples, a method of using an automated inventory system (AIS) is disclosed. The method may comprise detecting when an item is placed within an enclosure by a control system. The control system may be in communication with one or more RFID readers by detecting an RFID tag on the item. The enclosure may be for storing one or more items. Each of the items may be tagged with an RFID (radio frequency identification) tag. The enclosure may comprise a plurality of interior surfaces that defines an interior space within the enclosure. Further one or more access points within the interior surfaces may allow access to the items to pass in and out of the enclosure. The control system may also add the item to an inventory list associated with the enclosure, when the RFID tag associated with the item is detected within the enclosure by any of the one or more RFID readers. The control system may remove the item by the control system, from the inventory list when the RFID tag associated with the item is no longer detected by any of the one or more RFID readers.

Still further, a methodology may be implemented for addressing circumstances in which an RFID tag present in an containment environment is not consistently read during periodic RFID scans. This can occur, for example, when an RFID tag is defective, damaged, or mis-applied, such as to metal or liquid items. In some cases, an RFID tag may be read accurately during one scan, but not read during a subsequent scan, and then read accurately during a further subsequent scan, and so on.

To address this issue of inconsistent or spurious scanning of RFID tags, in one or more examples, software associated with the inventory management system may implement a buffer factor associated with RFID scans.

### BRIEF DESCRIPTION OF THE DRAWINGS

In the drawings, like reference numbers generally indicate identical, functionally similar, and/or structurally similar elements.

FIG. 1A illustrates an embodiment of an automated-inventory module (AIM).

FIG. 1B illustrates an embodiment wherein enclosure is a shipping container.

FIG. 1C illustrates a front view of an embodiment of posterior doors.

FIG. 1D illustrates internal hardware within automated-inventory module.

FIG. 2A illustrates an embodiment of a panel.

FIG. 2B illustrates another embodiment of a panel.

FIG. 3A illustrates another embodiment of panel herein middle layer comprises a plurality of beams.

FIG. 3B illustrates another embodiment of panel only comprising first exterior layer.

FIG. 4A illustrates panel comprising a support frame.

FIG. 4B illustrates a side section view of panel comprising a support frame.

FIG. 5 illustrates enclosure 101 with panels covering a plurality of interior surfaces.

FIG. 6 illustrates an exploded view of panel attached to door.

FIG. 7 illustrates an embodiment of a shelving unit.

FIG. 8 illustrates a closer view of a bar comprising a plurality of slots, and a plurality of catches.

FIG. 9A illustrates an embodiment of a shelf assembly.

FIG. 9B illustrates how shelf assembly can attach to vertical bars.

FIG. 10 illustrates a shelf base comprising an RFID reader.

FIG. 11 illustrates an embodiment of a front guard at a locked position.

FIG. 12 illustrates an embodiment of front guard at an unlocked position.

FIG. 13 illustrates a supply chain and e-commerce platform.

FIG. 14 illustrates an automated supply chain and e-commerce (ASCE) platform.

FIG. 15 illustrates an example embodiment of how a contractor can access one or more items from automated-inventory module.

FIG. 16 illustrates how items can be managed and monitored through ASCE platform.

FIG. 17 illustrates a dashboard main screen embodiment of supply system application.

FIG. 18A-18D illustrates screen embodiments of supply system application as viewed by contractor.

FIG. 19A-19C illustrates a screen embodiments of supply system application 1401 as viewed by vendors.

FIG. 20 is a flow diagram of a method of inventory tracking according to one or more examples.

FIG. 21 is a flow diagram of a method of inventory tracking according to one or more examples.

FIG. 22 is a block diagram of a computing resource implementing a method of inventory tracking according to one or more examples.

### DETAILED DESCRIPTION

This disclosure relates to an improved wall panel for an automated inventory module. This disclosure also relates to an improved shelving unit for a shelving container. This disclosure further relates to an automated inventory system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system and business-related constraints), and that these goals will vary from one implementation to another. It will also be appreciated that such development effort might be complex and time consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

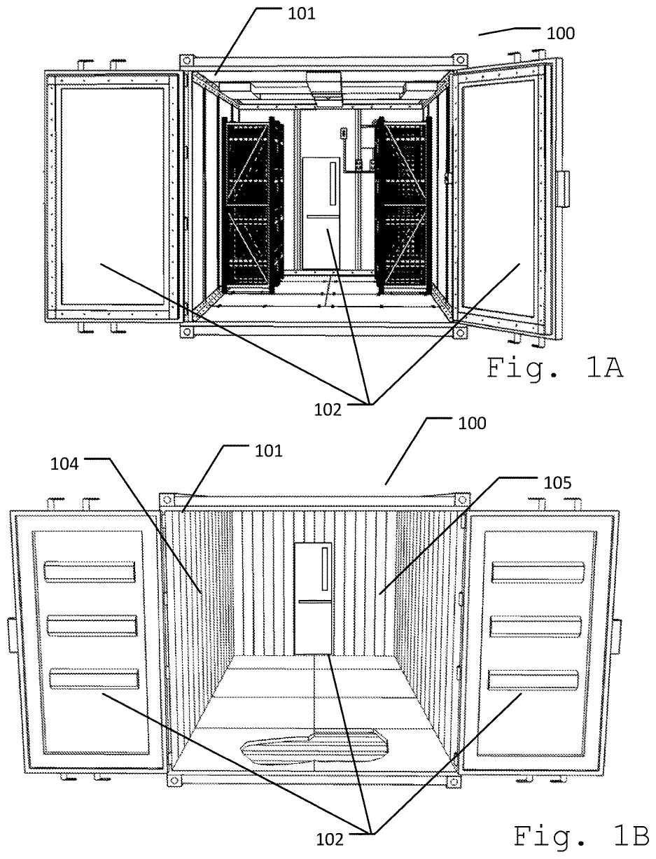

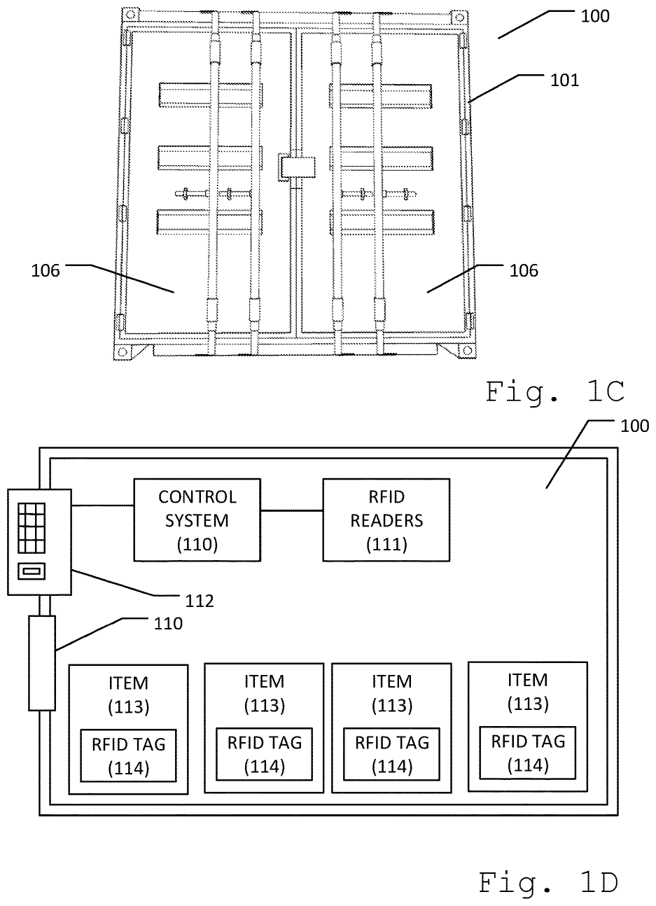

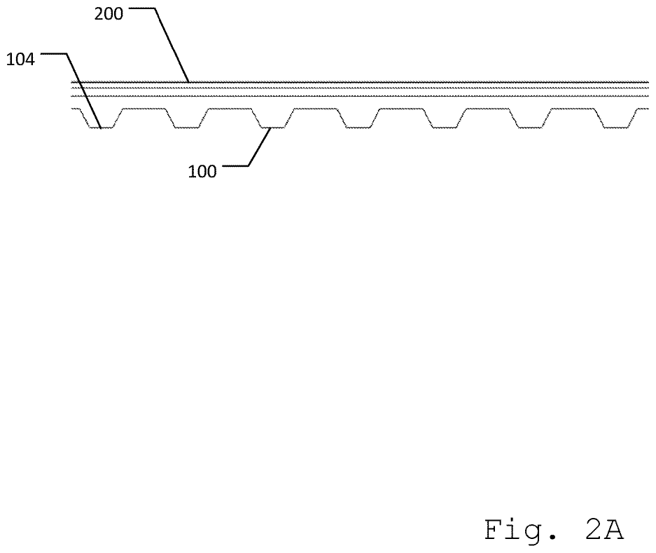

FIG. 1A illustrates an embodiment of an automated-inventory module (AIM) 100. AIM 100 can comprise an enclosure 101 for storing inventory. In a preferred embodiment, enclosure 101 can be mobile. Enclosure 101 can comprise one or more access points 102 such as a door. In one embodiment, enclosure 101 and access points 102 can be made of a durable material such as metal.

FIG. 1B illustrates an embodiment wherein enclosure 101 is a shipping container. A shipping container is a large reusable container that is designed to withstand shipment and storage of products within a transport system. Most often, shipping containers are made primarily of steel and are capable of storing and transporting items over various modes of transport including ship, rail, or truck. Shipping containers are typically generally in the shape of a rectangular prism. In a preferred, enclosure 101 can be large enough to allow one or more individuals to access and move around inside enclosure 101. Enclosure 101 can comprise interior surfaces 104 defined by structures such as walls, a floor, and a ceiling. Such structures can together define an interior space 105 within enclosure 101. Furthermore, surfaces 104 can be corrugated to provide strength and allow stacking of enclosures 101. Access points 102 can be placed within inner surfaces to allow inventory and individuals to move into and out of interior space 105.

In one embodiment, enclosure can comprise a frame a floor, a pair of sidewalls, a front-end wall, a ceiling, and a door assembly 106. Frame can provide structural support and connect the parts of shipping container together. In an example embodiment, frame can comprise a plurality of rails, a plurality of posts, and a door header. Rails can provide lateral structure for frame. Rails can comprise a pair of top side rails, a pair of bottom side rails, a top end rail and a bottom end rail. Posts can provide vertical support to the four corners of frame. Posts can connect each rail and door header together through a plurality of corner fittings. In such structure, each corner fitting can connect the eight corners of enclosure 101. Corner fittings can provide shipping container capability for stacking, handing and securing the containers. Door header can be the lateral structure placed at the top rear of enclosure 101 where door assembly 106 can be placed. In one embodiment, frame can further comprise a plurality of bottom cross members. Bottom cross members can be the lateral frame structures attached to bottom side rails. Bottom cross members can support floor of enclosure 101. In such embodiment, sidewalls are the interior surfaces covering the opposite sides of shipping container enclosure, and the front-end interior surface is interior surface opposite posterior doors. In one embodiment, a door can be built into front-end wall.

FIG. 1C illustrates a front view of an embodiment of posterior doors 106. In one embodiment, posterior doors 106 can comprise a pair of door panels 107, a plurality of handles 108, and a locking system 109. Door panels 107 can be vertical panels that form at the rear end portion of enclosure 101. Door panels 107 can provide access to interior space of enclosure 101. Handles 108 can be placed at the external surface of door panels 107. Handles 108 can serve as a grip to open door panels 107. Locking system 109 can be used to secure posterior doors 106.

FIG. 1D illustrates internal hardware within AIM 100. AIM 100 can comprise a control system 110, one or more RFID readers 111 in communication with control system 110, and an access control system 112. Inventory can include one or more items 113, each item having a radio frequency identification (RFID) tag 114. RFID tag 114 can comprise a unique identifier that can be read by RFID reader 111. RFID tag 114 can allow each item 113 to be identified and tracked by AIM control system 101. Furthermore, in one embodiment, RFID tag 114 can comprise information on items 113, such as component name, manufacturer, etc.

In one embodiment, access control system 112 can be a device, such as an electric lock, installed on access points 102. In such embodiment, access control system 112 can comprise of electronic reader, and/or a keypad that can allow an individual to enter an access key on control system 110 before granting access to items 113 within enclosure 101. For purposes of this disclosure, access key can be a keyed-in alphanumeric character, or a machine-readable code entered on AIM 100 through access control system 112.

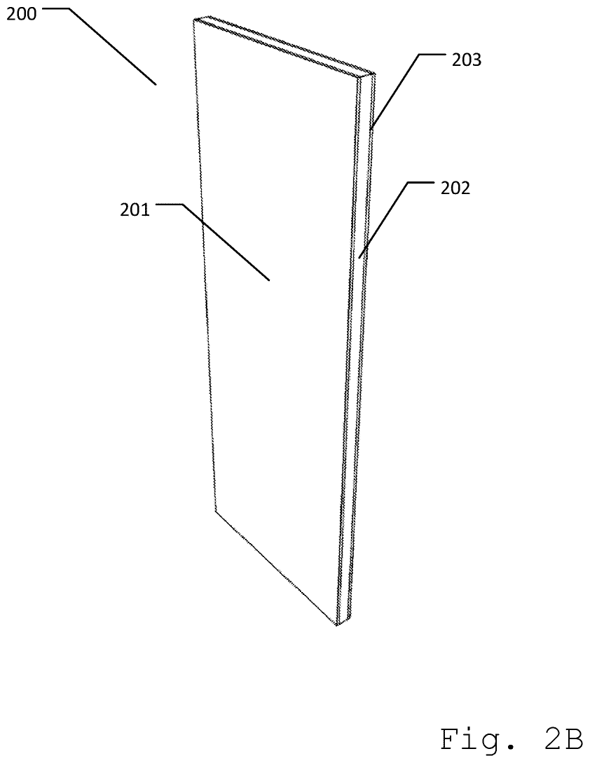

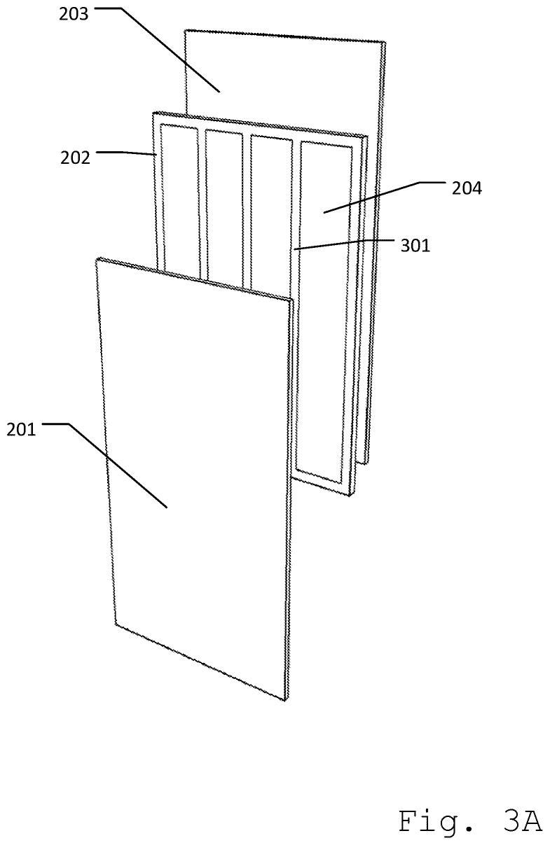

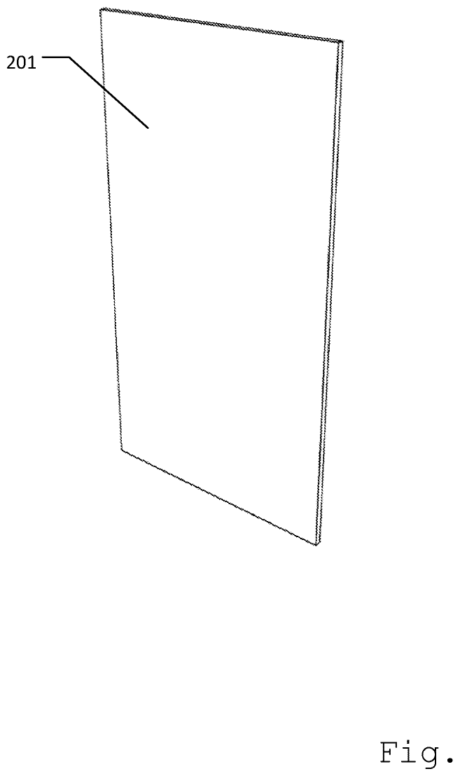

FIG. 2A illustrates an embodiment of a wall panel 200. Wall panel 200 can be installed on interior surfaces 104 of enclosure 101. In one embodiment, wall panel 200 can consist essentially of a flat metallic sheet material that is attachable to or mountable at an interior surface 104. In a preferred embodiment, such metallic sheet is aluminum or steel. In such embodiment, wall panel 200 can decrease the dispersion of RFID signals, thus providing a better transmission of electromagnetic signals within enclosure 101 between RFID tags 114 and RFID reader 111.

FIG. 2B illustrates another embodiment of wall panel 200. In one embodiment, panel 200 can comprise a substantially flat first exterior layer 201, a middle layer 202, and a second exterior layer 203. First exterior layer 201 can have a first side and a second side. First exterior layer 201 first side can face the middle of the interior space 104 of the shipping container. Middle layer 202 can also have a first side and a second side. Middle layer 202 first side can be adjacent first exterior layer 201, while Middle layer 202 second side can be adjacent second exterior layer 203. Second exterior layer 202 can have a first side and a second side. Second exterior layer 202 first side can face middle layer 202, while second exterior layer 202 second side can face interior surface of AIM 100, while second exterior layer 203 faces interior surface to which panel 200 is mounted. In one embodiment, first exterior layer 201 can be made of one or more metallic sheets such as aluminum or steel. In another embodiment, second exterior layer 203 can be made of one or more metallic sheets such as aluminum or steel. Middle layer 202 can be between first exterior layer 201 and second exterior layer 203. In one embodiment, middle layer 202 can comprise of an insulation material 204. Insulation material 204 can be any material that reduces or prevents transmission of heat, sound, or electricity. Some examples of insulation material 204 can include but is not limited to fiberglass insulation, slag wool, mineral wool, stone wool, polyurethane (PU) foam, etc. In a preferred embodiment, insulation material 204 can be a stone wool. In such embodiment, middle layer 202 can be sound absorbing and fire-resistant.

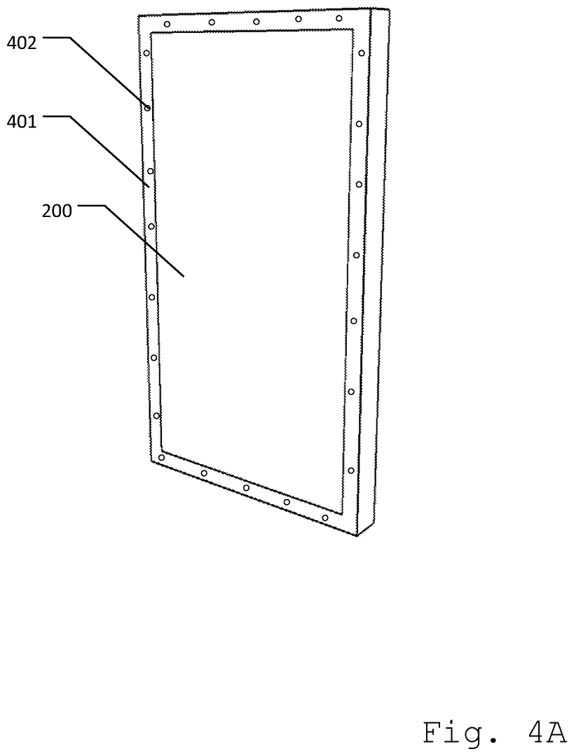

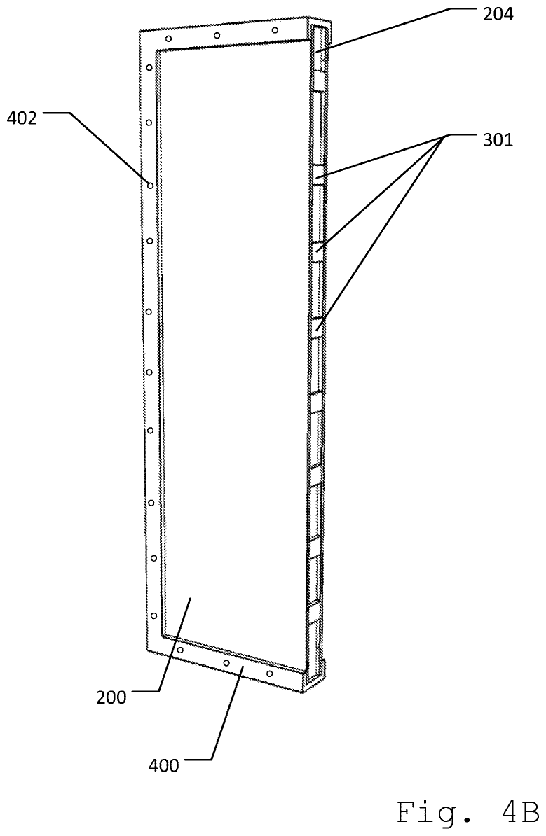

FIG. 3A illustrates another embodiment of panel 200 herein middle layer 202 comprises a plurality of beams 301. Beams 301 can provide framing and sturdy structure for panel 200. Beams 301 can be made of any durable material such as wood or metal. In this embodiment, beams 301 can be placed within middle layer 202. In one embodiment, beams 301 can be horizontal. In another embodiment, as shown in FIG. 3. In other embodiments, beams 301 can have a lateral structure. In such embodiment, insulation material 204 can be placed within the voids created between first exterior layer 201, second exterior layer 203, and beams 301.

FIG. 3B illustrates another embodiment of panel 200 only comprising first exterior layer 201. In this embodiment, only a flat metallic sheet material attached to the inner surface of enclosure 101.

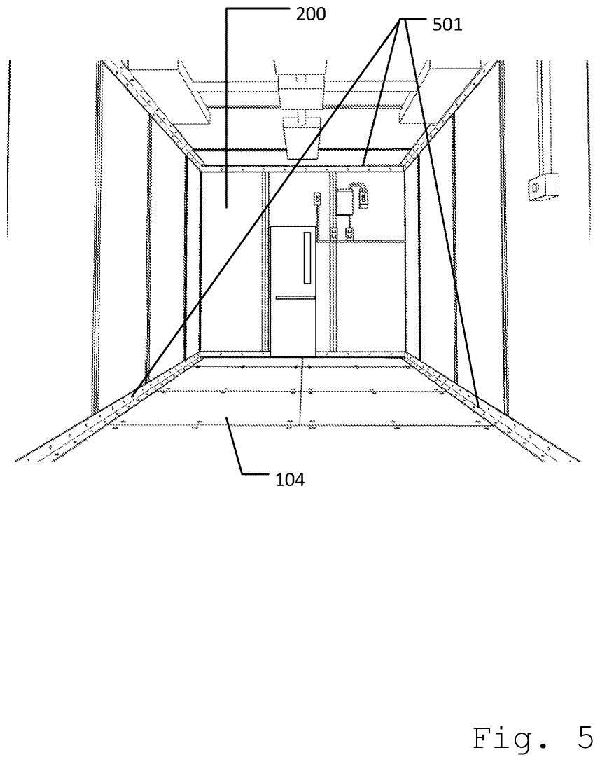

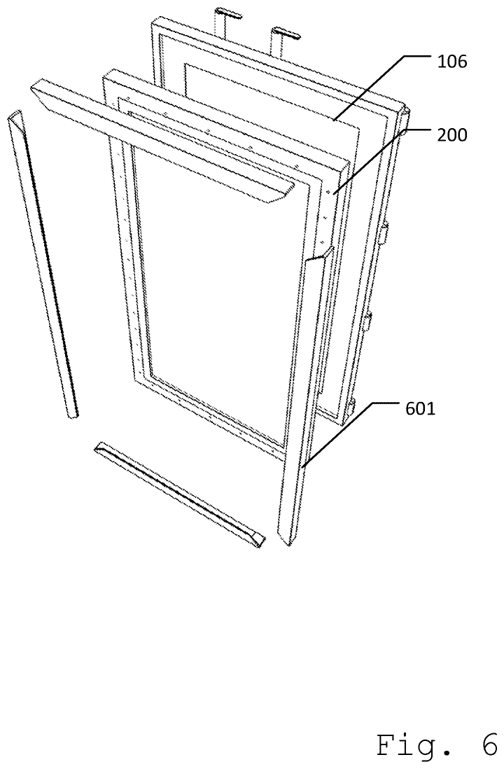

FIG. 4A illustrates panel 200 comprising a support frame 401. In one embodiment, support frame 401 can be a U-shaped frame that holds first exterior layer 201, second exterior layer 203, and middle layer 202 together. In such embodiment, support frame 401 can be wrapped around the outer ends of panel 200 exposing a large surface area of first exterior layer 201. Frame fasteners 402 such as rivets can connect support frame 401 to first exterior layer 201 and second exterior layer 203

FIG. 4B illustrates a side section view of panel 200 comprising support frame 401.

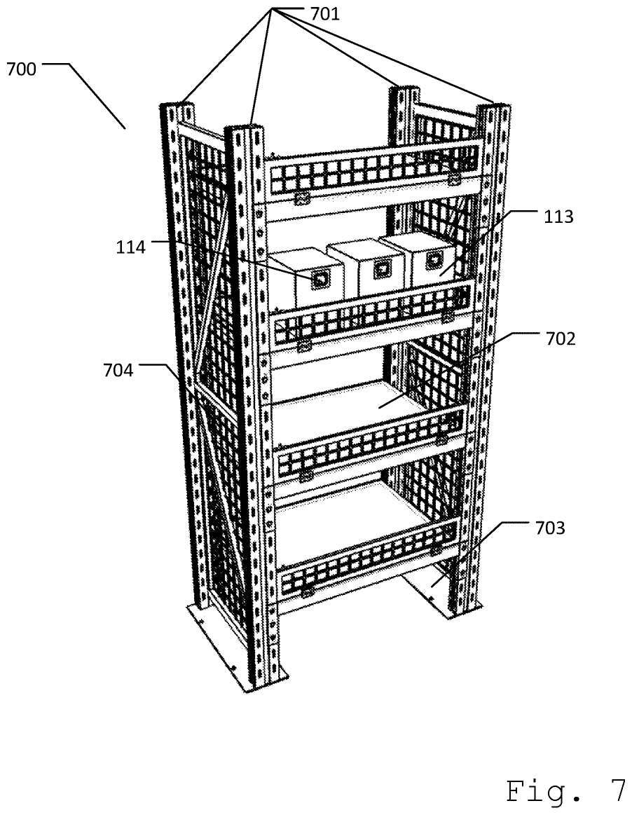

FIG. 5 illustrates enclosure 101 with panels 200 covering a plurality of interior surfaces 104. Interior surfaces can define the interior space within enclosure 101. In one embodiment, each interior surface can be substantially covered by one or more panels 200. In one embodiment wherein one panel 200 on one interior surface 104 meets another panel 200 on another interior surface or a floor, both such panels 200 or the one panel 200 and the floor can be connected to each other using an “L” bracket 501 and frame fasteners 402. “L” bracket 501 can be made of durable material such as steel or aluminum. Having an irregular wall surface can cause the signals within the container to be diffracted as electromagnetic waves can bend when an obstacle is encountered. Thus, the flat surface of each panel 200 can enhance the transmission of signals within the container since less diffraction will occur as compared to corrugated steel walls. In another embodiment, panels can be affixed using any method known in the art including but not limited to welding, cementing, gluing or fastening using fasteners. In one embodiment, panels 200 attached to floor 102 can be substantially flat, but textured for traction.

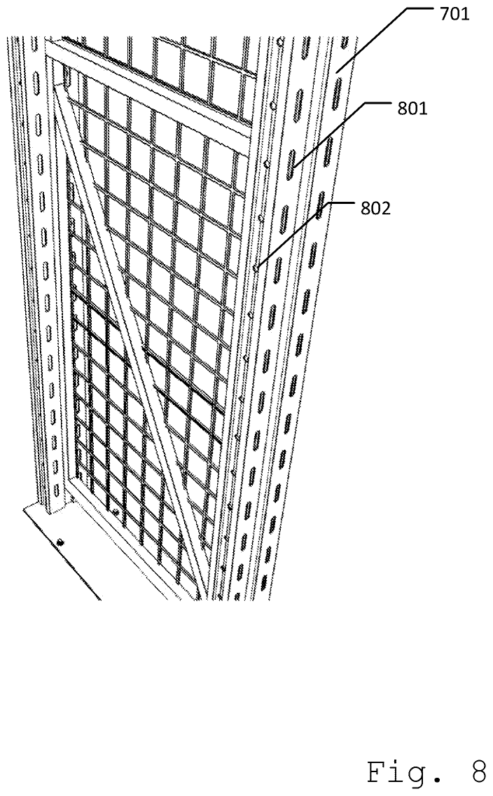

FIG. 6 illustrates an exploded view of panel 200 attached to door panel 107. In one embodiment, panel 200 can be mounted to the back surface of door panel 107 through L-shaped frame 601. In this embodiment, each L-shaped frame 601 can be welded to door panel 107. In such embodiment, each L-shaped frame 601 can be facing towards the wall panel direction, such that the horizontal beams of L-shaped frame 601 can attach to the outer front sides of panel 200 while the vertical beams of L-shaped frame 601 can rest around the sides of panel 200. In such structure, the outer edges of the vertical beams of L-shaped frame 501 can be welded to the back surface of door panel 107.

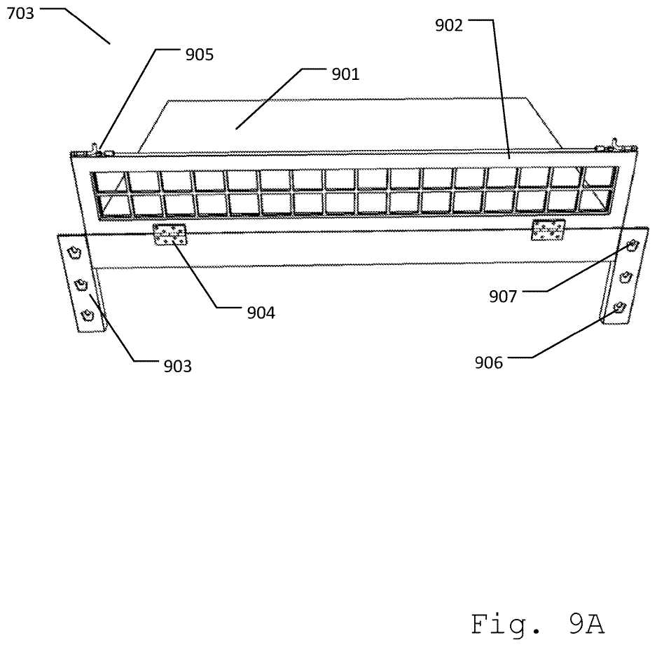

FIG. 7 illustrates an embodiment of a shelving unit 700. Shelving unit 700 can be a flexible display system capable of holding items 113. Thus, each item 113 stored within enclosure 101 can comprise RFID tag 114, which can be readable by RFID reader 111. In one embodiment, shelving unit 700 can be made of a non-ferrous material that allows electromagnetic signals to pass through. In one embodiment, shelving unit 700 can comprise vertical supports 701, one or more shelf assemblies 702, and one or more bases 703. Vertical supports 701 can, in one embodiment, be vertical bars placed at the four corners of shelving unit 700, while each shelf assembly 702 can be a horizontal surface that provides storage or display for items 113. In one embodiment, stand 703 can be placed at the bottom of each pair of bars 701. Bases 703 can ensure that shelving unit 700 is securely attached in place and can maintain an upright position within the shipping container. In one embodiment, stand 703 can attach shelving unit 700 to the bottom cross member of enclosure 101. In one embodiment, shelving unit 700 can further comprise a wall bracket 704. Wall bracket 704 can be a gridded sidewall that connects vertical supports 701 on common sides to each other. 701.

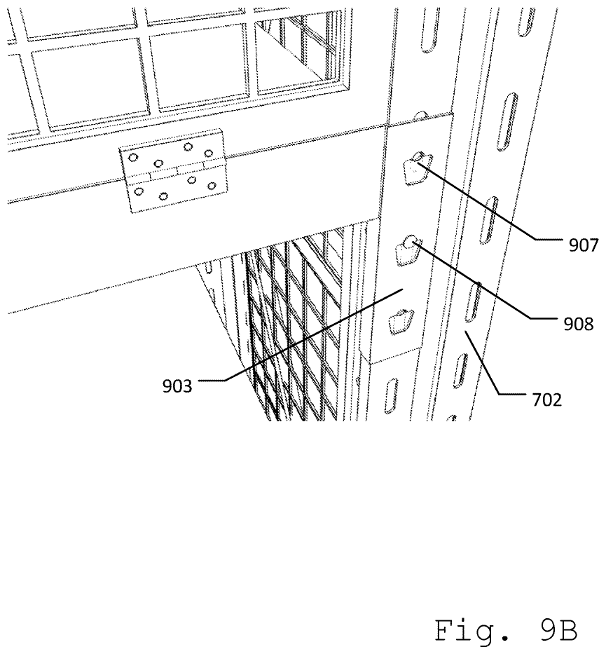

FIG. 8 illustrates a closer view of vertical support 701 comprising a plurality of slots 801, and a plurality of catches 802. Each slot 801 can be an opening that is uniformly distributed across the front surface of each vertical support 701 while catches 802 can be an opening that is uniformly distributed at the opposite side surfaces of each vertical support 701. In one embodiment, each catch 802 can be compatible with a latch fastener.

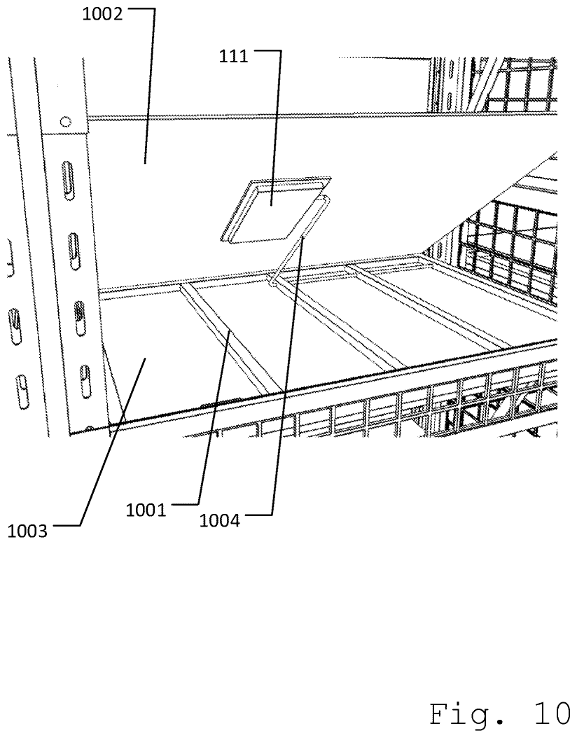

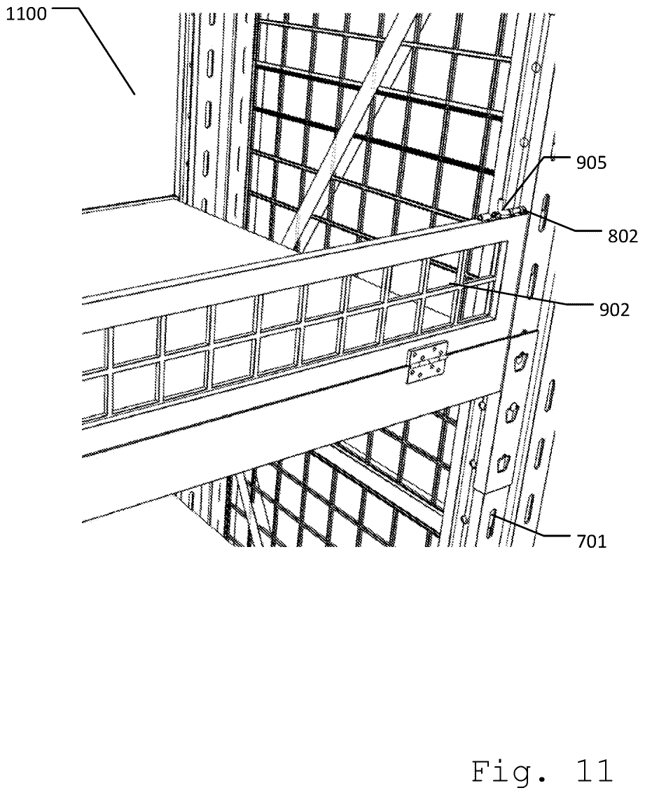

FIG. 9A illustrates an embodiment of shelf assembly 702 comprising a shelf base 901, a front guard 902, and a plurality of brackets 903. Shelf base 901 can be the portion of shelf assembly 702 that provides support to items 113. In one embodiment, front guard 902 can be a hinged railing attached to shelf base 901. In this embodiment, front guard 902 can comprise one or more hinges 904 and one or more latches 905. Hinges 904 can connect the bottom edge portion of front guard 902 the front side section of shelf base 901. Furthermore, hinges 904 can allow front guard 902 to be maneuverable into a locked position and an unlocked position. Latches 905 can keep front guard 902 in a locked position or an unlocked position, which can be further discussed below. In one embodiment, each bracket 903 can be an angular bar placed at the corners of shelf base 901. In such embodiment, bracket 903 placed on each side of shelf base 901 can be connectable to each pair of bars 701. In one embodiment, each bracket 903 can comprise one or more holes 906. Holes 906 can be aligned with slots 801 on bars 701. In this embodiment, shelf assembly 702 can attach to pair of bars 701 by attaching one or more fastening devices to holes 906 on bracket 903 with slots 801 on bars 701.

In another embodiment, each hole 906 can further comprise a notch 907. Notch 907 can be an extended hanging portion within each hole 906. In one embodiment, notch 907 can be slanted backwards. In this embodiment, notch 907 can be insertable within slots 801 of vertical support 701.

FIG. 9B illustrates how shelf assembly 702 can attach to vertical bars 701. In one embodiment, the exact vertical positioning of shelf assembly 702 within the pairs of vertical bars 701 can be adjustable. In such embodiment, shelf base 901 can rest on vertical bars 701 through brackets 903. In this embodiment, holes 906 on shelf base 901 can first be aligned with slots 801 of bars 701. Then, notches 907 on brackets 903 can be inserted within slots 801 of bars 701. This can allow shelf assembly 702 to be mounted and rest on each pair of bars 701. In another embodiment, one or more fastening devices 908 can be used to fasten brackets 903 with vertical bars 701. Fastening devices 908 can include but is not limited to screws, or nuts and bolts.

FIG. 10 illustrates shelf base 901 comprising an RFID reader 111. In one embodiment shelf base 901 can comprise a plurality of shelf beams 1001, a top platform 1002, and a bottom platform 1003. Shelf beams 1001 can be elongated beams placed in between top platform 1002 and bottom platform 1003. Shelf beams 1001 can provide support for top platform 1002. Top platform 1002 and bottom platform 1003 can be a flat sheet material that covers shelf beams 1001. In one embodiment, RFID reader 111 can be placed within shelf base 901. In such embodiment, RFID reader 111 can be placed in between top platform 1002 and bottom platform 1003. In this embodiment, RFID reader 111 can be positionable within the voids created between shelf beams 1001, top platform 1002, and bottom platform 1003. In one embodiment, RFID reader 111 can be mounted at the bottom of top platform 1002 while the cable coming out from RFID reader 111 can go through shelf beams 1001. This is to ensure that RFID reader 111 maintains its position within shelf base 901. For purposes of this disclosure, each shelf assembly 702 can comprise RFID reader 111. In such structure, RFID reader 111 can maintain contact with each items 113 by scanning and gathering information from RFID tag 114 attached to each item 113. As such, each shelf assembly 702 can comprise RFID reader 111 that can be connected to control system 110 via cable 1004.

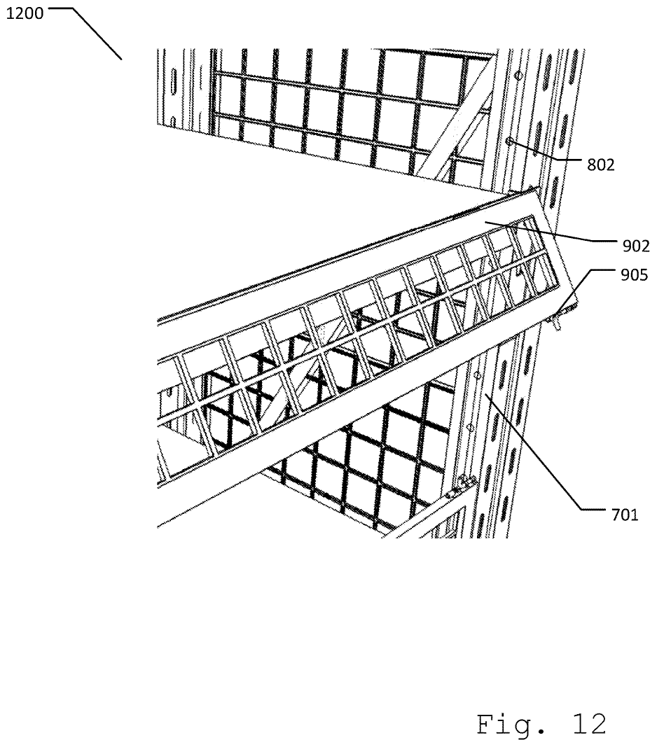

FIG. 11 illustrates an embodiment of front guard 902 at a locked position 1100. In one embodiment, latches 905 can be placed at the top edge of front guard 902. In locked position 1100, front guard 902 can be at an upright position such that front guard 902 can ensure that products within shelf assembly 702 are kept in place. In such position, latches 905 can be fastened to catch 802 of bars 701 to keep front guard 902 in locked position 1100.

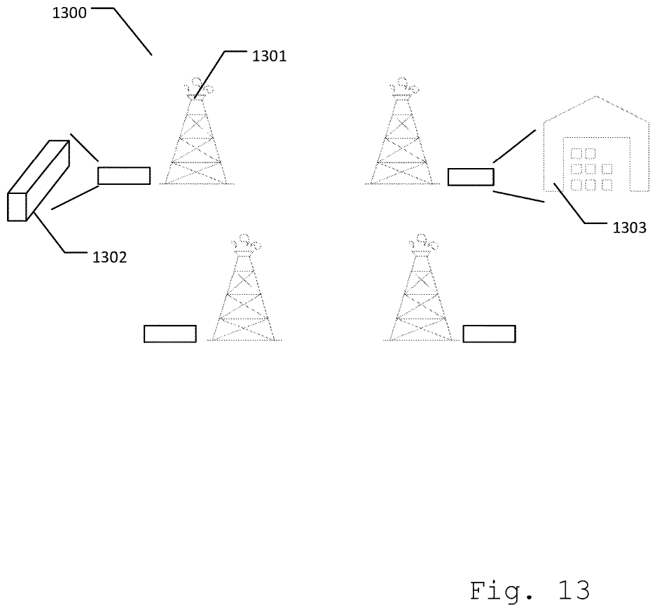

FIG. 12 illustrates an embodiment of front guard 902 at an unlocked position 1200. In such position, latch 905 can be unfastened from catch 802 allowing front guard 902 to hang downwards. In unlocked position 1200, the opening of shelf assembly 702 can be larger, which can allow easier access to items 113.

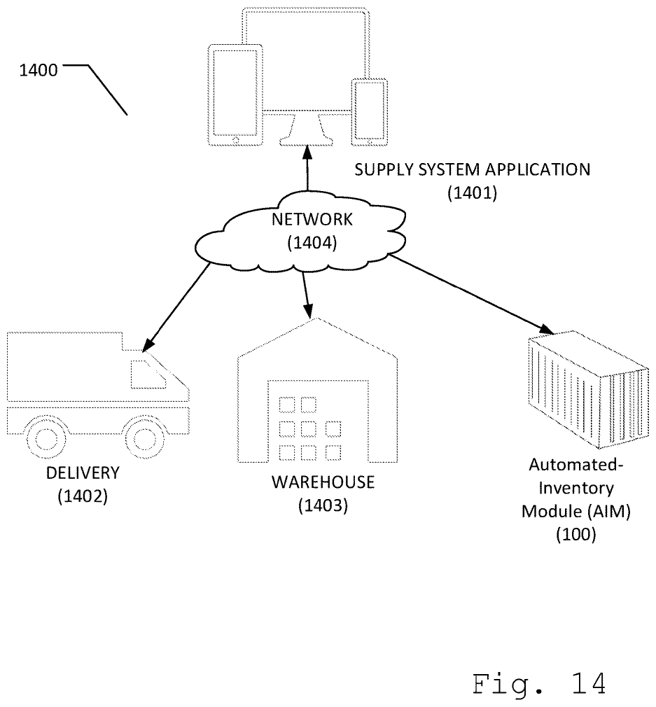

FIG. 13 illustrates a region 1300 comprising a plurality of worksites each with local storages such as a container 1302 or a warehouse 1303.

FIG. 14 illustrates an automated supply chain and e-commerce (ASCE) platform 1400. In this embodiment, ASCE platform 1400 can connect vendors with product consumers. In such embodiment, ASCE platform 1400 can comprise a supply system application 1401. Supply system application 1401 can be accessible via a website or mobile application. Supply system application 1401 can comprise business logic for a server. In one embodiment, supply system application 1401 can be configured to manage and monitor a supply chain. In such embodiment, one or more automated-inventory vehicle (AIV) system 1402, one or more automated-inventory warehouses (AIW) 1403, and one or more automated-inventory module (AIM) 100 can be interconnected through supply system application 1401. Supply system application 1401 can allow consumers and vendors to connect and know where inventory is in real time. In a preferred embodiment, vendors, consumers, or a third-party provider of the ASCE platform 1400 can set ordering parameters that ASCE platform can use to determine when to reorder inventory, what to order, and/or in what quantities. Examples of parameters can include a minimum quantity for a supply, a maximum quantity, delivery schedules, and approved supply lists. Network 1404 can be a local area network (LAN), a wide area network (WAN), a piconet, or a combination of LANs, WANs, or piconets. One illustrative LAN is a network within a single business. One illustrative WAN is the Internet. AIV system 1402 can allow vendors to monitor and manage supplies as supplies are moved from one location to another. AIW 1403 can be a warehouse wherein supplies are stored before being sold to a consumer or to a local storage such as AIM 100. AIW 1403 can also provide rapid fulfillment of orders since each product stored within the smart warehouse can be radio-frequency identification (RFID) controlled. As such, each item received, shipped, delivered, stored, etc. can be updated in the automated-inventory system in real-time. Thus, in one embodiment, AIW 1403 can have customizable inventory. AIM 100 can be used to store essential supplies or parts. In one embodiment, AIM 100 can be mobile, such that each AIM 100 can be picked up from one location and then be placed in another location. In such embodiment, each AIM 100 can be strategically placed near each work site 1301. In this embodiment, supply system application 1401 can connect with consumer's existing supply chain management and/or vendor's inventory platform. As such, supply system application 1401 can improve real-time inventory information, provide interconnected supply chain, provide real operational control, allow purchase orders automation, can reduce down time, and can improve vendor margins.

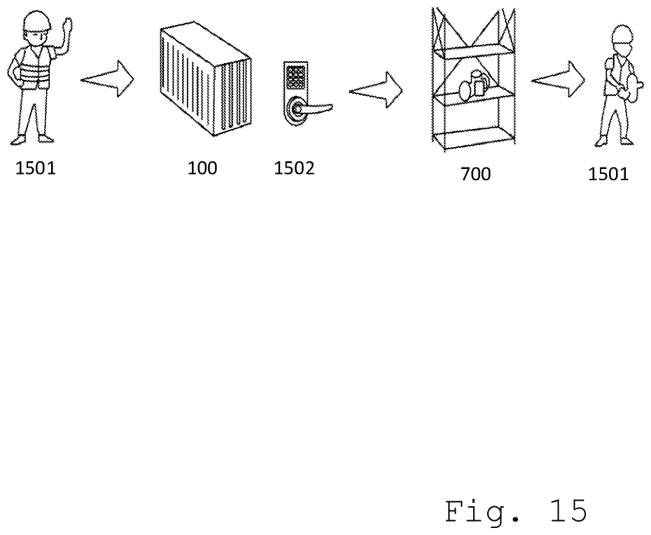

FIG. 15 illustrates an example embodiment of how a consumer 1501 can access one or more items 113 from AIM 100. Initially, consumer 1501 can access supply system application 1401 to determine whether item 113 is in AIM 100. If an item 113 is not in AIM 100, consumer 1501 can direct ASCE platform 1400 to move item 113 to AIM 100. Consumer can access AIM using an access key that provided to an access control 1502 of AIM 100. As such, consumer 1501 can enter AIM 100, grab the supply, and remove it from AIM 100. In this scenario, AIM 100 can be located near the contractor's drilling rig site 1301, which can lessen the non-productive time of going to and from a location to pick up items 113.

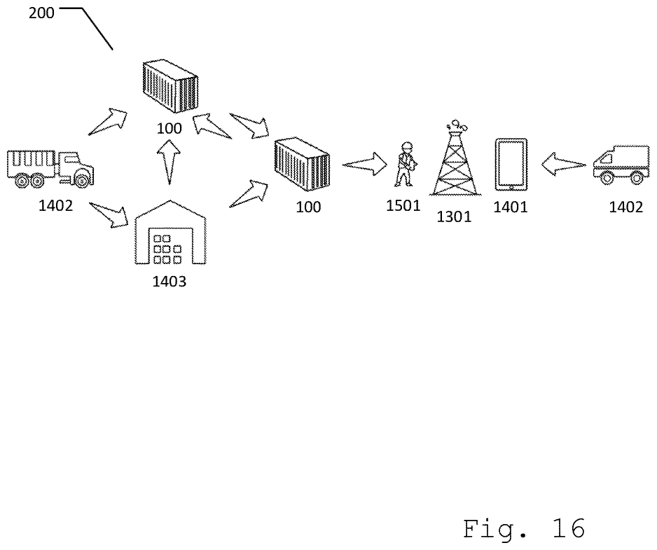

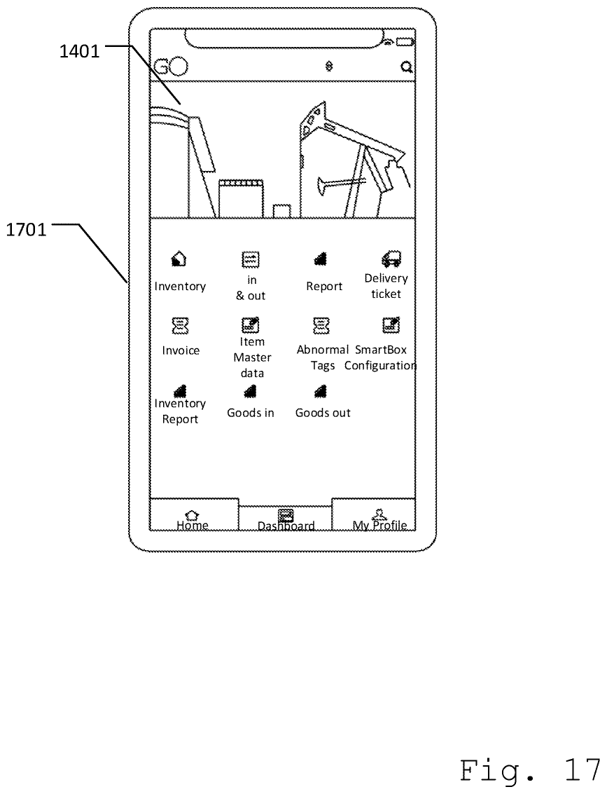

FIG. 16 illustrates how items 113 can be managed and monitored through ASCE platform 1400. In an example scenario, the vendor can provide consumers 1501 with items 113 that are commonly needed for work site 1301. In such scenario, items 113 can be stored in AIM 100, which can be continuously replenished by the vendor. In this scenario, inventory of items 113 that are placed within AIM 100 can also be recorded, monitored, and tracked. In one embodiment, AIM 100 can automatically register items 113 that consumer 1501 took out and can automatically register an order for the items that were took out through supply system application 1401. In such embodiment, AIM 100 can also record the quantity of items 113 that were took out. Orders can also be verified and monitored through supply system application 1401, such that expenditures can also be tracked. Further in another embodiment, when wrong parts are taken out from AIM 100, consumer 1501 can put it back and the automated-inventory module can register the item as returned in the supply system application. Parts replacement can also be handled through supply system application 1401. Further, in one embodiment, AIM 100 can be connected with AIW 1403. In such embodiment, AIW 1403 can have real time updates on supplies inventories of AIM 100. In such embodiments, vendors can know the needs of their customer's (contractor's 1501) in real-time. In case, wherein items 113 are low, vendors can replenish the parts needed by their customers in a timely manner. Moreover, vendors can receive notification when their own inventory are low and can prepare stocks for the next delivery run. AIM 100 can be strategically placed near drilling rig site 1301 for fast access. Once order is placed, consumer 1501 can pick up the orders as soon as access key 1502 is received from supply system application 1401. Thus, cutting large amount of time in waiting for orders and picking up orders from a warehouse. Furthermore, through ASCE platform 1400, vendors and consumers 1501 can have a real-time knowledge of items 113 that they have through supply system application 1401. In such embodiment, control system 110 can detect when item 113 is placed within enclosure 101, and can add the item 113 to an inventory list associated with enclosure 101 when the RFID tag associated with the item is detected within the enclosure by any of the one or more RFID readers 111. Control system 110 can also remove item 113 from the inventory list when the RFID tag associated with the item is no longer detected by any of the one or more RFID readers 111.

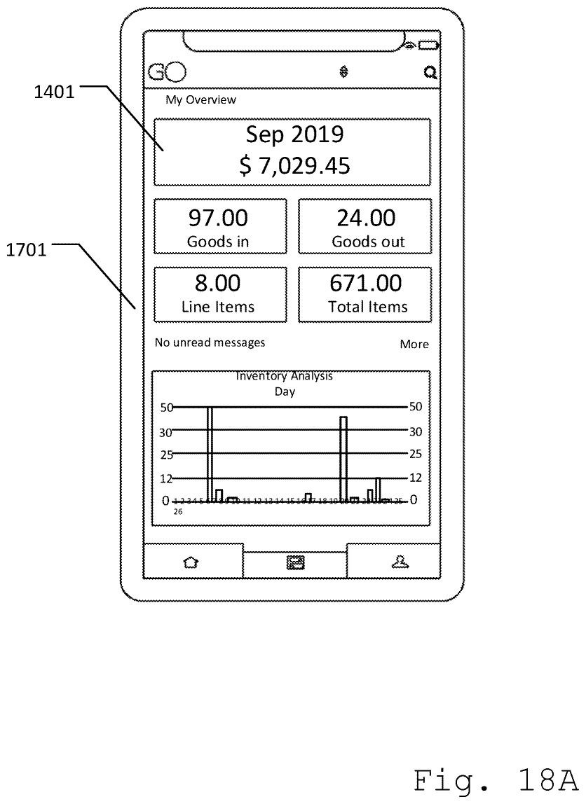

FIG. 17 illustrates a dashboard main screen embodiment of supply system application 1401. In this embodiment, supply system application 1401 can show relevant details of items 113 for both consumers 1501 and vendors. In one embodiment, supply system application 1401 can be accessible to both contractors and vendors through an electronic mobile device 1701. Electronic mobile device 1701 can be a desktop computer, laptop, tablet, personal digital assistant (PDA) or smart phone. In one embodiment, each consumer 1501 can register and create a user account on supply system application 1401 to be able to access the dashboard main screen. Similarly, each vendor will need to register and create a user account on supply system application 1401. In such embodiment, the dashboard and tools that can be accessible to the user can depend on the type of the user's account. As a non-limiting embodiment, a user can either have a contractor's account or a vendor's account, which can be further discussed below. In one example, users with contractor's account pick out parts of equipment from the pictures displayed on supply system application 1401, which can be more convenient for the users as they wouldn't have to remember the exact part numbers of the parts they needed. Such access may not be available or may be different from the users with vendor's account. In another example, vendors can manage item details, description, prices, etc. through online supply system application 1401. Such access can only be available to users with vendor's account.

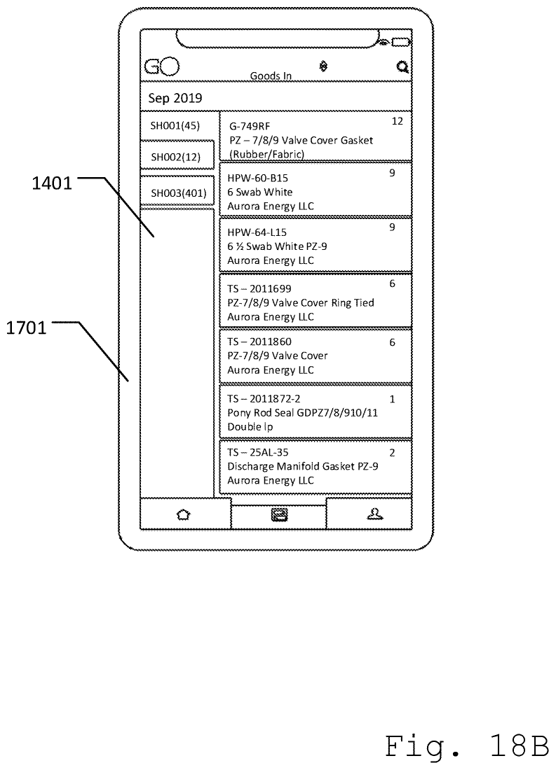

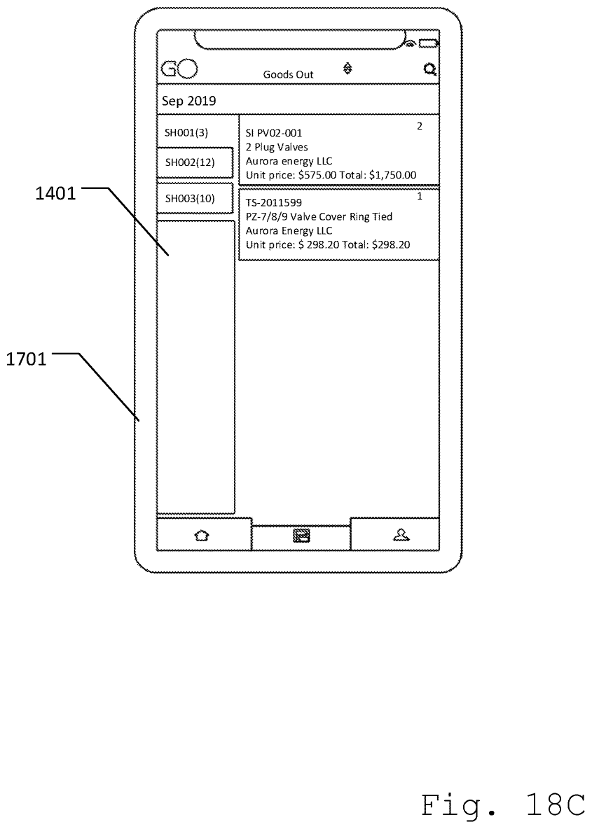

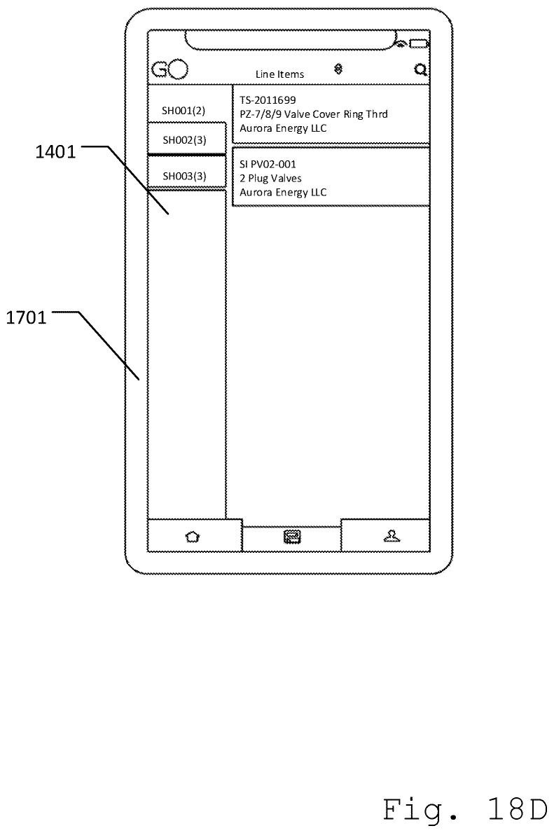

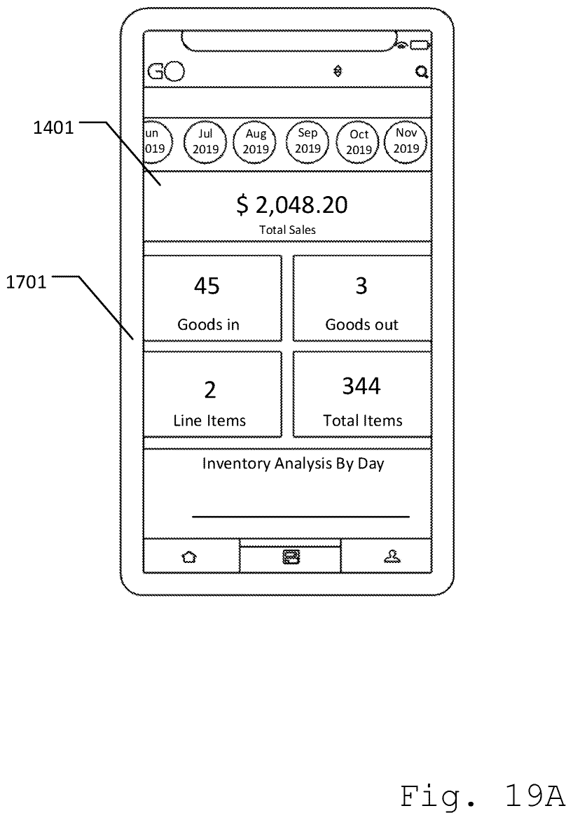

FIG. 18A-18D illustrates screen embodiments of supply system application 1401 as viewed by consumer 1501. In this embodiment, consumer 1501 can use his electronic mobile device 1701 to access a home page overview of supply system application 1401. In this embodiment, consumer 1501 can view details relevant to its user account such as amount of expenditure, list of goods in and goods out from AIM 100, current inventories, and, in some embodiments, parameters for automated ordering.

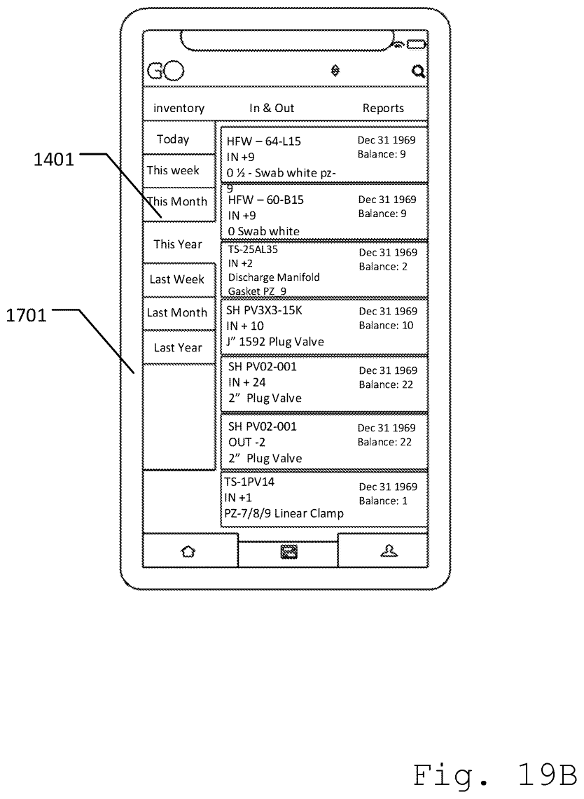

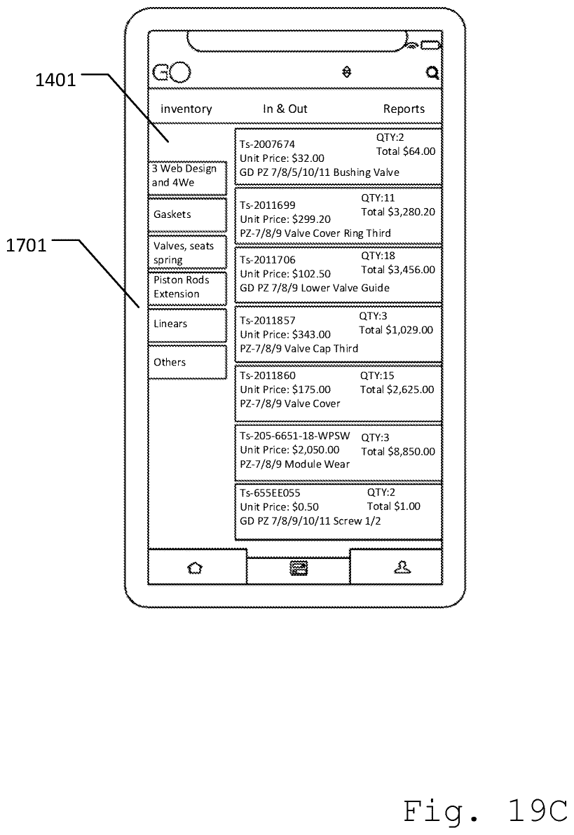

FIG. 19A-19C illustrates a screen embodiments of supply system application 1401 as viewed by vendors. In this embodiment, vendors can use his electronic mobile device 1701 to access supply system application 1401. In such embodiment, the vendor can view inventory report page, in and out of supplies (by week, month, year, etc.), and inventory report (by part or category) on supply system application 1401.

Various examples of systems and methods for inventory tracking in near real time are disclosed herein. The examples variously involve the use of one or more RFID scanners to scan RFID tags to track the inventory as it is checked into and out of a containment environment in which the items of inventory are stored. One issue that may arise with such systems is that occasionally, an RFID tag in the containment environment may not be read by the one or more RFID scanners during a scan of the containment environment. Such a situation may occur, for example, if an RFID tag associated with a particular item of inventory is damaged, or if the RFID tag is applied to a metal surface of the item of inventory (which may impede proper scanning).

In examples described herein, an RFID scanning system may be provided to periodically scan the containment environment; this is an example of “near real time” monitoring as described herein. In some situations, an RFID tag associated with an item of inventory may only be intermittently read from one scan to the next. This can lead to uncertainty as to the actual presence or absence of the particular item from the containment environment. That is, when a particular RFID tag is read intermittently by the RFID scanning system, the inventory tracking system may show an RFID-tagged item of inventory leaving and then re-entering the containment environment, when in fact the item of inventory may have been present throughout a sequence of scans by the RFID scanning system. Such uncertainty is undesirable.

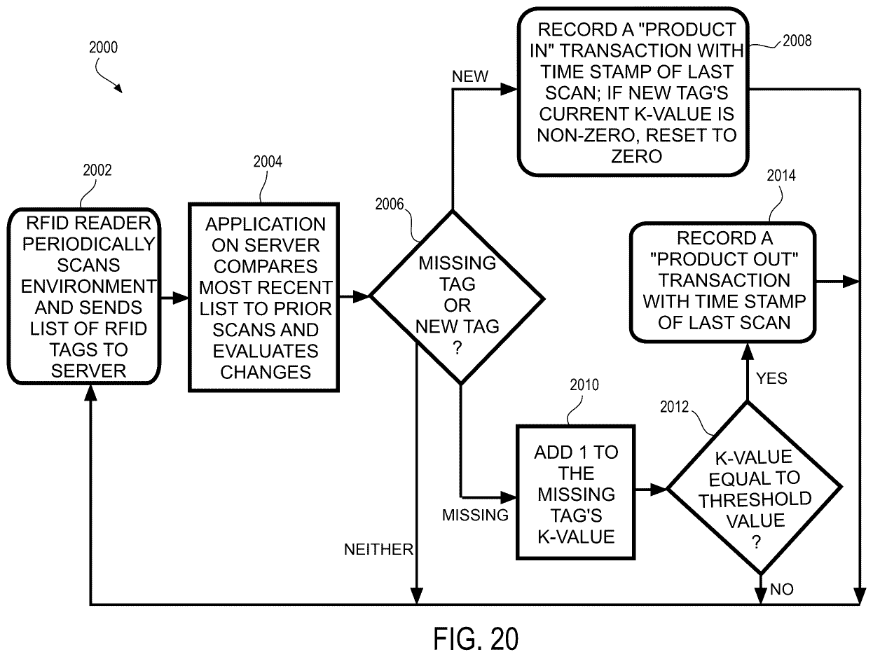

Turning to FIG. 20, there is shown a flow diagram of a method 2000 for inventory tracking in accordance with one example. In the example of FIG. 20, an inventory tracking system uses RFID scanning data from one or more RFID scanners to track inventory in near real time. In one example, inventory in a containment environment may be scanned periodically, for example, every fifteen minutes, although scanning may occur more or less frequently in any given implementation.

In one example, the inventory tracking system sends the RFID scanning data from the one or more RFID scanners to a central software application, which may be local, cloud-based, or otherwise network-connected. In operation, occasionally an RFID-tagged item may not be read during one scan, then read successfully on a subsequent scan, and so on. As described above, this may be due to an RFID tag being damaged or misapplied.

When an RFID-tagged item is read intermittently in this way, the inventory tracking system shows the RFID-tagged item leaving and re-entering the containment environment, when in fact it was present for each of a succession of scans. To compensate for this behavior, in various examples, the inventory tracking system may apply a “buffer factor,” (also referred to as a “K-value,” as described below), to more accurately reflect actual presence or absence of RFID-tagged items in the containment environment.

With reference to FIG. 20, as shown in block 2002, the one or more RFID readers may scan the containment environment periodically and send a list of detected RFID tags to the central software application (which may be referred to herein as a “server”) implementing the inventory tracking system. In block 2004, the central software application on the server compares this most recent list to prior scans and evaluates any changes that are reflected in such comparison.

In block 2006, the central server application makes a determination whether any new RFID tags or missing RFID tags are reflected in the new scan of the containment environment. In the event that a new RFID tag is detected, then in block 2008, the central server application records a “PRODUCT IN” transaction, along with a time stamp of the current scan. Operation of the central server application then returns to block 2002 for a subsequent periodic scan of the containment environment. Also in block 2008, if the newly detected RFID tag has a non-zero K-value, the tag's K-value is reset to zero.

On the other hand, if in block 2006 it is determined that an RFID-tagged item is determined to be missing from the list generated in block 2002, through comparison with a previous list, then in block 2010, a buffer factor, referred to herein as a “K-value,” for the missing item is incremented by one in the central server application's database. Then, in block 2012, the central server application determines whether the K-value for the RFID-tagged item is equal to a predetermined threshold value. In one example, the predetermined threshold value may be ten, but the threshold value may vary from implementation to implementation, and may be selected by a system administrator.

As shown in FIG. 20, If in block 2006 it is determined that neither a new tag nor a missing tag is detected, the process returns to block 2002 in advance of a subsequent periodic scan of the containment environment.

In examples, the central server application will only mark an RFID-tagged item as having left the containment environment after the threshold K-value for that item has been reached, meaning that the item was not detected for the threshold number of consecutive scans. Thus, in block 2014, if the threshold K-value has been reached for a particular item, the central server application records a “PRODUCT OUT” transaction with the time stamp of the new scan. Operation of the central server application then returns to block 2002 for a subsequent periodic scan of the containment environment.

On the other hand, if in block 2012 it is determined that the K-value of the (potentially) missing RFID-tagged item has not reached the predetermined K-value threshold, operation of the central server application returns to block 2002 for a subsequent scan without recording the item as being “OUT.”

In some examples, the time stamp of the “PRODUCT OUT” transaction (block 2014) may be matched with the time stamp of the first scan reflecting the RFID tag not being detected. This allows for keeping the time stamp of the “PRODUCT OUT” transaction aligned with the time stamps, and can be coordinated with other data, such as pictures taken by motion-activated cameras in the containment environment, in order to ascertain if and how the item was removed from the containment environment.

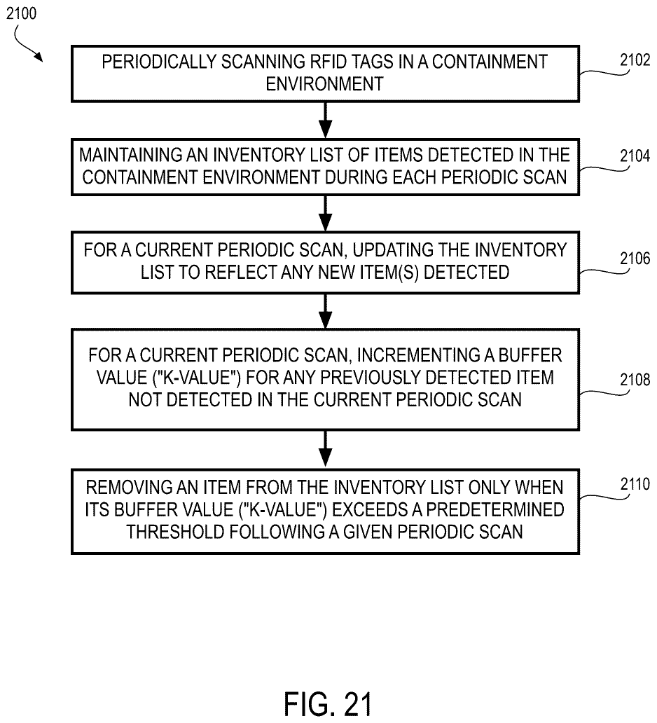

FIG. 21 is a flow diagram illustrating a method 2100 of inventory tracking according to one or more examples. In the example of FIG. 21, a first step 2102 is to periodically scan RFID tags in a containment environment. In step 2104, a central server application maintains and updates an inventory list of items detected in the containment environment. This involves for each periodic scan of the containment environment, in step 2106, updating the inventory list to reflect any new item or items detected.

Maintaining the inventory list further involves, in step 2108, for each periodic scan, incrementing a buffer value (“K-value”) for any previously detected item not detected in the current periodic scan. Finally, in step 2110, an item of inventory is removed from the inventory list only when its buffer value (“K-value”) exceeds a predetermined threshold.

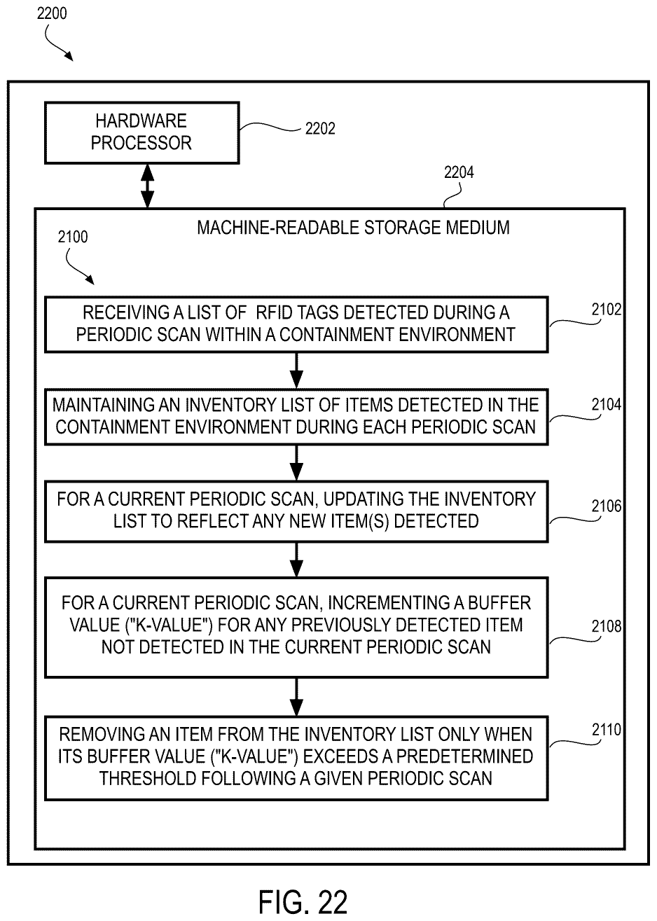

FIG. 22 is a block diagram representing a computing resource 2200 implementing a method of inventory management according to one or more examples. The computing resource 2200 may be, for example and without limitation, a personal desktop computer (e.g., a personal computer), a mobile computing platform (e.g., a laptop or tablet), or a desktop computer accessing cloud computing resources. Computing resource 2200 may include at least one hardware processor 2202 and a non-transitory machine-readable storage medium 2204. As illustrated, machine readable medium 2104 may store instructions, that when executed by hardware processor 2202 (either directly or via emulation/virtualization), cause hardware processor 2202 to perform the method 2100 of inventory tracking described above with reference to FIG. 21.

In various examples, hardware processor 2202 may be, for example and without limitation, a microcontroller, a central processing unit (“CPU”), a digital signal processor (“DSP”), a programmed logic array (“PLA”), or a custom processing circuit. Instructions may be executed by one or more processors, such as one or more central processing units (“CPU”), digital signal processors (“DSPs)”, general purpose microprocessors, application specific integrated circuits (“ASICs”), field programmable logic arrays (“FPGAs”), or other equivalent integrated or discrete logic circuitry. Accordingly, the term “processor,” as used herein refers to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. A “controller,” including one or more processors, may use electrical signals and digital algorithms to perform its receptive, analytic, and control functions, which may further include corrective functions. Thus, a controller is a specific type of processing circuitry, comprising one or more processors and memory, that implements control functions by way of generating control signals.

A computer-readable media may be any available media that may be accessed by a computer. By way of example, such computer-readable media may comprise random access memory (“RAM”), read-only memory (“ROM”), electrically-erasable/programmable read-only memory (“EEPROM”), compact disc ROM (“CD-ROM”) or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and Blu-ray® disc where disks usually reproduce data magnetically, while discs reproduce data optically with lasers.

Note also that the software implemented aspects of the subject matter hereof are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The detailed description is made with reference to the accompanying drawings and is provided to assist in a comprehensive understanding of various example embodiments of the present disclosure. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments. In addition, descriptions of well-known functions and constructions may be omitted for clarity and conciseness. Accordingly, those of ordinary skill in the art will recognize that various changes and modifications of the examples described herein can be made without departing from the spirit and scope of the present disclosure.

Use of the phrases “capable of,” “capable to,” “operable to,” “configured to,” or “programmed to” in one or more embodiments, refers to some apparatus, logic, hardware, and/or element designed in such a way to enable the use of the apparatus, logic, hardware, and/or element in a specified manner. Use of the phrase “exceed” in one or more embodiments, indicates that a measured value could be higher than a pre-determined threshold (e.g., an upper threshold), or lower than a pre-determined threshold (e.g., a lower threshold). When a pre-determined threshold range (defined by an upper threshold and a lower threshold) is used, the use of the phrase “exceed” in one or more embodiments could also indicate a measured value is outside the pre-determined threshold range (e.g., higher than the upper threshold or lower than the lower threshold). The subject matter of the present disclosure is provided as examples of apparatus, systems, methods, circuits, and programs for performing the features described in the present disclosure. However, further features or variations are contemplated in addition to the features described above. It is contemplated that the implementation of the components and functions of the present disclosure can be done with any newly arising technology that may replace any of the above-implemented technologies.

Various modifications to the disclosure will be readily apparent to those skilled in the art, and the generic principles defined herein may be applied to other variations without departing from the spirit or scope of the present disclosure. Throughout the present disclosure the terms “example,” “examples,” or “exemplary” indicate examples or instances and do not imply or require any preference for the noted examples. Thus, the present disclosure is not to be limited to the examples and designs described herein but is to be accorded the widest scope consistent with the principles and novel features disclosed.

What is claimed is:

1. An inventory management system comprising
a containment environment for storing one or more items, each of said items tagged with a radio frequency identification (RFID) tag;
one or more RFID readers disposed within the containment environment, each of the one or more RFID readers controlled to periodically scan RFID tags within the containment environment and provide a list of RFID tags; and
a central server application in communication with the one or more RFID readers, wherein the central server application is configured to:
maintain an inventory list associated with the containment environment based on the periodic scans of RFID tags within the containment environment;
detect when a new item is placed within the containment environment by scanning an RFID tag associated with the new item not reflected in a previous scan of the containment environment;
add the new item to the inventory list when the RFID tag associated with the new item is detected within the containment environment by any of the one or more RFID readers; and
remove an existing inventory item from said inventory list associated with the containment environment only when said RFID tag associated with the existing inventory item is not detected by the one or more RFID readers for a predetermined number of successive periodic scans of the RFID tags within the containment environment.

2. The inventory management system of claim 1, wherein the central server application is further configured to associate a time stamp with the addition of a new item to the inventory list.

3. The inventory management system of claim 1, wherein the central server is further configured to associate a time stamp with the removal of an existing inventory item.

4. The inventory management system of claim 1, wherein the containment environment comprising a plurality of interior surfaces that defines an interior space within said enclosure.

5. The inventory management system of claim 1 further comprising one or more shelving units placed within said enclosure, each of said shelving unit comprising one or more shelf assemblies capable of supporting said item.

6. The inventory management system of claim 5, wherein each of said shelf assemblies comprises an RFID reader of said one or more RFID readers.

7. The inventory control system of claim 1 further comprising an access control system that controls access to said enclosure.

8. The inventory control system of claim 1 wherein said enclosure is a shipping container.

9. A method for inventory management, comprising
providing a containment environment for storing one or more items, each of said items tagged with a radio frequency identification (RFID) tag;
providing one or more RFID readers disposed within the containment environment, each of the one or more RFID readers controlled to periodically scan RFID tags within the containment environment and provide a list of RFID tags; and
coupling a central server application to the one or more RFID readers;
maintaining an inventory list associated with the containment environment based on the periodic scans of RFID tags within the containment environment;
detecting when a new item is placed within the containment environment by scanning an RFID tag associated with the new item not reflected in a previous scan of the containment environment;
adding the new item to the inventory list when the RFID tag associated with the new item is detected within the containment environment by any of the one or more RFID readers; and
removing an existing inventory item from said inventory list associated with the containment environment only when said RFID tag associated with the existing inventory item is not detected by the one or more RFID readers for a predetermined number of successive periodic scans of the RFID tags within the containment environment.

10. The method of claim 9, further comprising associating a time stamp with the addition of a new item to the inventory list.

11. The method of claim 9, further comprising associating a time stamp with the removal of an existing inventory item.

12. The method of claim 9, wherein the containment environment comprises a plurality of interior surfaces that defines an interior space within said enclosure.

13. The method of claim 9, wherein the containment environment includes one or more shelving units placed within said enclosure, each of said shelving unit comprising one or more shelf assemblies capable of supporting said item.

14. The method of claim 13, wherein each of said shelf assemblies comprises an RFID reader of said one or more RFID readers.

15. The method of claim 9, further comprising providing an access control system that controls access to said enclosure.

16. The method of claim 9, wherein said containment environment is a shipping container.

17. A computer-readable medium tangibly embodying instructions that, when executed by a processor, perform a method for inventory management, comprising:
providing a containment environment for storing one or more items, each of said items tagged with a radio frequency identification (RFID) tag;
providing one or more RFID readers disposed within the containment environment, each of the one or more RFID readers controlled to periodically scan RFID tags within the containment environment and provide a list of RFID tags; and
coupling a central server application to the one or more RFID readers;
maintaining an inventory list associated with the containment environment based on the periodic scans of RFID tags within the containment environment;
detecting when a new item is placed within the containment environment by scanning an RFID tag associated with the new item not reflected in a previous scan of the containment environment;
adding the new item to the inventory list when the RFID tag associated with the new item is detected within the containment environment by any of the one or more RFID readers; and
removing an existing inventory item from said inventory list associated with the containment environment only when said RFID tag associated with the existing inventory item is not detected by the one or more RFID readers for a predetermined number of successive periodic scans of the RFID tags within the containment environment.

18. The computer-readable medium of claim 17, further comprising associating a time stamp with the addition of a new item to the inventory list.

19. The computer-readable medium of claim 17, further comprising associating a time stamp with the removal of an existing inventory item.

20. The computer-readable medium of claim 17, wherein the containment environment comprises a plurality of interior surfaces that defines an interior space within said enclosure.
